(19) United States
(12) Patent Application Publication
(10) Pub. No.: US 2018/0022053 A1
(43) Pub. Date: Jan. 25, 2018

(54) Method and Device for Forming at Least One Bottom on a Hose Piece

(71) Applicant: Windmöller & Hölscher KG, Lengerich (DE)

(72) Inventors: Uwe Köhn, Osnabrück (DE); Thomas Hawighorst, Hasbergen (DE)

(21) Appl. No.: 15/541,638

(22) PCT Filed: Jan. 12, 2016
(86) PCT No.: PCT/EP2016/050453

§ 371 Date: Jul. 5, 2017

(30) Foreign Application Priority Data
Jan. 30, 2015 (DE) 10 2015 201 691.9

(51) Int. Cl. B31B 70/84; B29C 65/10; B31B 70/64; B29C 65/00; B31B 70/62; B29C 65/08; B29C 65/48

(52) U.S. Cl. CPC B31B 70/84; B29C 65/08; B29C 65/103; B29C 65/4815; B29C 66/53462; B29C 66/8511; B31B 70/62; B31B 70/64; B29L 2031/7128

(57) ABSTRACT

The invention relates to a method for forming at least one bottom on a hose piece (20), which comprises plastic material, wherein at least one end of the hose piece is pulled open along at least one first folding edge (21), a bottom rectangle (22) and triangular pockets (23) thus being formed; wherein side tabs (25, 26) of the bottom rectangle are folded back along two folding edges (24) spaced apart from the first folding edge in order to close the bottom, wherein the two side tabs then contact each other, and wherein a bottom cover sheet (31) is applied to the bottom and is connected to the side tabs and at least one triangular pocket by application of heat or by means of glue. The surfaces of the side tabs that come into contact and the triangular pockets are connected to each other at least in the region of the two folding edges, a connection (32) thus being formed.

The invention relates to a method for forming at least one bottom on a hose piece, which comprises plastic material, in accordance with the generic art of claim 1 and to a device for forming at least one bottom on a hose piece, which comprises plastic material, in accordance with the generic art of claim 10.

In the production of bags, in particular cross bottom bags, at least one end of the hose piece is pulled under formation of a bottom rectangle and triangular pockets along at least one first folding edge for forming a bottom. Then the two side tabs of the bottom rectangle which were produced in this manner are folded back along two folding edges which are at a distance from the first folding edge, wherein the two side tabs subsequently contact one another.

In hose pieces which comprise plastic materials these contact points or contact surfaces of the two side tabs remain unconnected. A fastening of the bottom now takes place by the applying of a bottom cover sheet which is connected to both side tabs. The bottom cover sheet is also connected to the part of the triangular pockets which is covered by it and not covered by the side tabs to the extent that no filling valve is present. If a valve is present, the bottom cover sheet is connected to the valve.

This method is especially efficient since the bottom is completely fastened with only one work step so that the bag is ready to receive a filling material and in particular can be completely loaded with a filling material.

However, it turned out in practice that often so-called trickle conduits are produced along the two folding edges along which in particular dusty filling material can exit to the outside. The reason for this is that due to the tolerances during the bag forming processes the bottom cover sheet is slightly smaller in its dimensions than the rectangle inscribed into the folded bottom has to be in order to reliably avoid that it projects over the edges of the bottom after the application.

Therefore, the present invention has the problem of suggesting a method and a device for avoiding the exiting of filling material from the finished bag.

This problem is solved in accordance with the invention by all features of claim 1. Possible embodiments of the invention are indicated in the dependent claims.

The present invention provides that the surfaces of the side tabs and of the triangular pockets which make contact at least in the area of the two folding edges are connected to each other, forming a connection. This area encloses parts of the second folding edges. If the side tabs are folded back, this produces contact surfaces—which are also triangular—between each side tab and each triangular pocket, wherein the particular contact surface of the side tab and the contact surface of the triangular pocket are connected to each other by a section of the second folding edge. The side tab and the triangular pocket are now connected to one another at least in a part of the contact surface in the area of this folding edge so that a possible trickle conduit is interrupted. A complete surface connection along this contact surface is not necessary to avoid trickle conduits. In fact, a connection produced only along a small part of this contact surface is preferred, wherein a small part is to be understood to be less than 20% of this contact surface, as a result of which the method can be carried out in an especially efficient manner.

However, the connected part advantageously extends to an area of the surface which is at a distance of at least 1 cm from the folding edge. A trickle conduit can be very easily avoided with this measure, wherein in addition the connection has a sufficient strength without having to fear that this connection loosens again.

Another embodiment provides that the connection is arranged in or on the folding edge in such a manner that that at least the area of the intersection of the folding edge with the diagonal comprises the triangular pocket. At this point the filling material exits to the outside in bags of the prior art so that the providing of the connection at this position adds a great advantage.

In order to create a strong and therefore permanent connection, it is advantageous if the connection, viewed from the point of intersection, extends at least 1 cm in the direction of the folding edge. In particular in conjunction with the advantageous feature described further above according to which the connection extends over a surface which begins on the folding edge and extends up to a distance of at least 1 cm from the latter, this results in a surface that is so great that it securely extends all the way to under a bottom cover sheet to be applied later even if the latter is shifted relative to the theoretical position on account of manufacturing tolerances. The exiting of filling material is especially well avoided in this manner.

As was already initially described, the invention relates to hose pieces comprising plastic material. In particular, hose pieces are concerned which consist exclusively of plastic material and comprise no other materials such as, for example, paper. Such hose pieces can consist of plastic sheeting material such as can be produced in sheet extrusion systems. Aside from forming a hose, other processing steps are not necessary here. However, hose pieces comprising plastic material can also contain a fabric which comprises, for example, small stretched plastic bands. This fabric can also be coated. In another variant such a hose piece can comprise fleece material which is also designated as non-woven material. A fleece material is characterized in that individual plastic fibers are connected to each other under the application of pressure and/or heat. Such a fleece material can also be provided with a coating or can form a laminate using at least one plastic film.

In order to be able now to form a connection in accordance with the method of the invention, a hot-air sealing method is advantageously used. The advantage resides in the fact that this is a very efficient method with which, in addition, sufficiently durable connections can be produced. In addition, the material is not too heavily stressed since only areas close to the surface participate in the sealing process. In a hot-air sealing method the areas of the two connection partners to be connected here, therefore, parts of the triangular tab and parts of the side tabs, are heated on their sides facing each other by blowing hot air in until plasticization and bringing them immediately in contact with each other. A subsequent pressing in a pressing slot which can be formed by two rollers advantageously takes place.

Another advantageous further development of the method provides that the connection takes place by an ultrasonic welding. The ultrasonic welding method is a welding method in which molecular friction and boundary surface friction are produced in the connection zone with high-frequency, mechanical oscillations. This produces heat at this boundary surface so that the material is rendered plastic here. A compression or pressing of this area results in a tight connection so that no filling material can escape.

Another embodiment provides producing an application of glue onto the areas intended for the connection. It is advantageous here to apply the glue before or at the latest during the folding back of the side tabs. However, it is especially advantageous to apply the glue prior to the opening of the bottom since this avoids that the glue passes on to the side wall of the subsequent bag and that an undesired adhesion of the triangular pocket to the side wall possibly takes place.

The glue is preferably applied with a glue nozzle. The glue track exiting from the glue nozzle can be directly introduced into the already produced or subsequently produced folding edge.

Known cold glues can be used as glues. However, heat-activatable hot melt, which is economical, is preferably applied. The latter is especially advantageous in the case of an application of glue which takes place prior to the opening of the bottoms. This hot melt hardens after the application so that the bottom opening or bottom closure can take place without the hot melt the adhering to the tools for the bottom opening or of the bottom closing, which could otherwise result in disturbances. During the bottom closing or after the bottom closing the hot melt can be reactivated by a charging of heat so that the connection between the triangular pocket and the side tab is now produced. If hot air is used during the production of the bottom for a durable closing of the bottom, as is well known, for example, for the application of a cover sheet, then the charging of heat produced for activating the hot melt is then already sufficient. Therefore, a separate heating device is not necessary.

Another advantageous variant of an application of glue is the introducing of a plastic extrudate into the second folding edge shortly before or during the folding over of the side tab. The plastic extrudate is a liquified plastic material, especially a plastic material which is the same as or similar to at least the surface of the hose piece. This is also an economical type of an application of glue. The further folding in of the side tab takes place here even before the hardening of the extrudate so that a connection is produced by the pressing or compression which prevents the filling material from exiting out of the interior of the bag.

All the previously cited methods for producing the connection preferably operate in cycles. That means that they are only put in the active state when they are located precisely opposite the areas to be connected. The appropriate tools are arranged as a rule standing still inside the machine while the hose piece is moved past the tool with a transport device which preferably moves in a uniform manner. It is of course provided that the area of the second fold edge in which the side tab is directly folded back onto the hose piece wall and not onto surface of the triangular pocket is bypassed. If this area is not bypassed, this would result in an undesired gluing which might make the bag unusable.

The above-cited problem is also solved in accordance with claim 10 by a device for forming a bottom on a hose piece comprising plastic material. The essential feature of the invention is a device with which the surfaces of the side tabs and the triangular pockets which make contact can be connected to each other at least in the area of the second folding tabs while forming a connection.

Such a device can be a hot air sealing device which is arranged in the area of a folding device with which one side tab can be folded back onto the corresponding triangular pockets along the second folding edges.

In another embodiment an exclusion nozzle can be arranged at the same position with which an extrudate can be placed into or directly adjacent to the folding edge.

In another advantageous embodiment of the invention an ultrasonic welding device can be provided which is arranged immediately after the above-cited folding device. A connection can be produced with this ultrasonic welding device in the area of the second folding edge when the side tab is already resting on the triangular pocket.

In another preferred embodiment of the invention an apparatus for applying a hot melt is provided which is also located inside the folding device or in front of it. However, it is especially advantageous if the latter is arranged in front of the device for opening the bottom of the hose piece.

Other advantages, features and details of the invention are apparent from the following description in which different exemplary embodiments are explained in detail with reference made to the figures. The features mentioned in the claims and in the specification can be essential for the invention individually or in any combinations. Features and details which are described in connection with the method according to the invention are of course valid in the framework of the entire disclosure even in connection with the pressure machine according to the invention and inversely so that reference is made or can be made reciprocally as regards the disclosure to the individual aspects of the invention. In the individual figures:

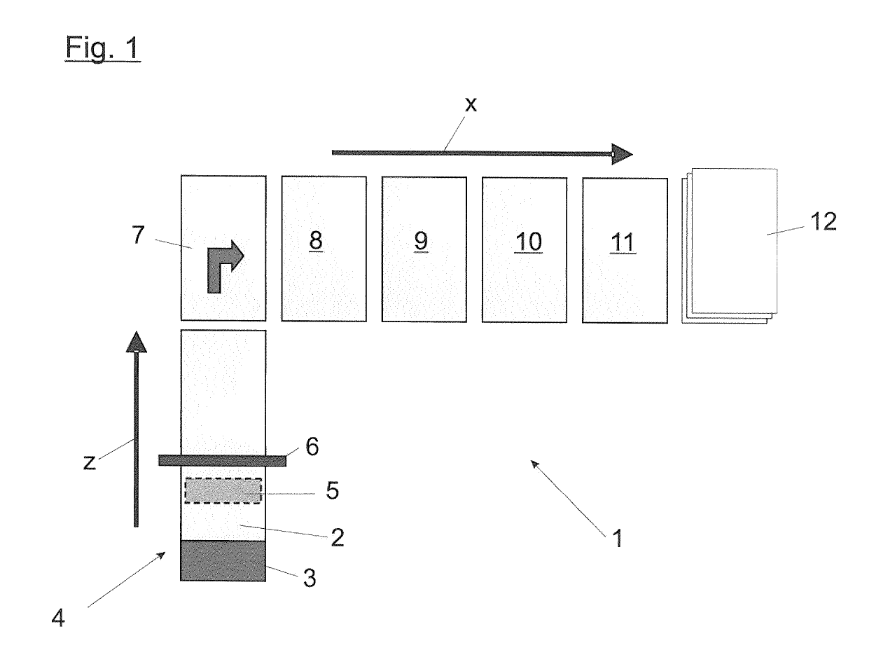

FIG. 1 shows a basic sketch of a device for producing bags containing plastic,

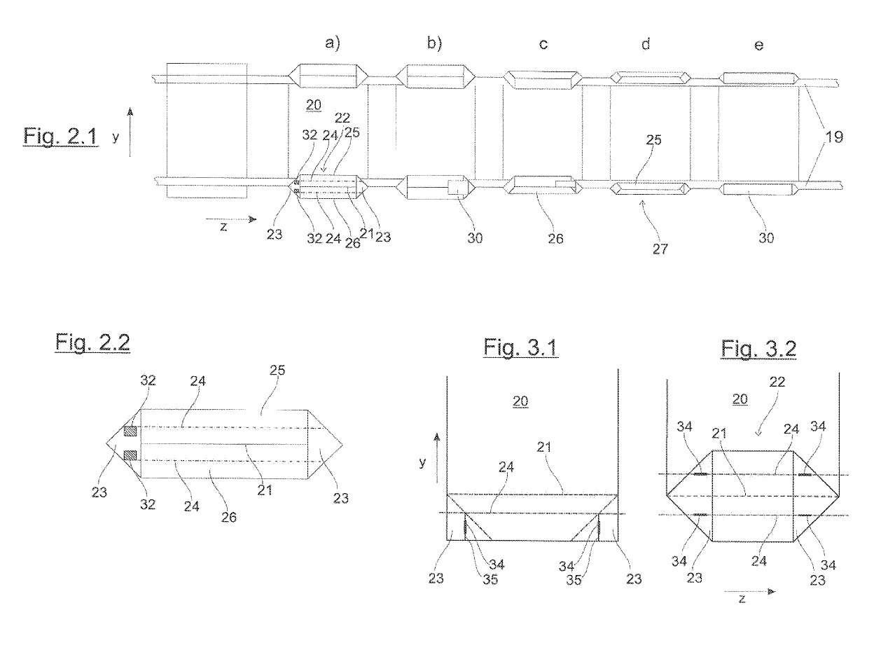

FIG. 2 shows essential steps for producing a bag from a hose piece,

FIG. 3 shows a hose piece with tracks of glue on the later folding edges,

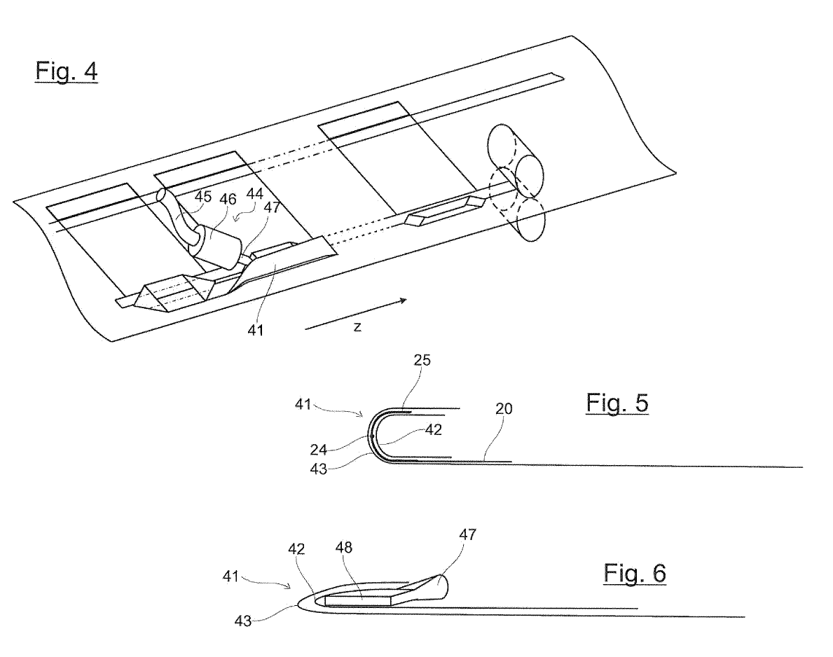

FIG. 4 shows an exemplary embodiment4 with a hot-air sealing device,

FIG. 5 shows a cross section of a folding-over element from FIG. 4,

FIG. 6 another cross section of a folding-over element from FIG. 4,

FIG. 7 shows another view of the exemplary embodiment according to FIG. 4,

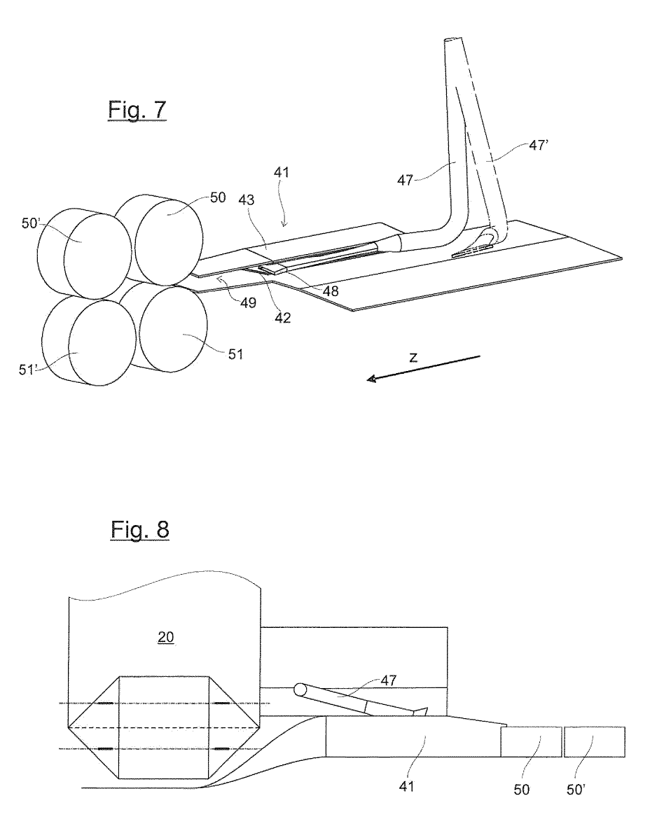

FIG. 8 shows a top view onto the exemplary embodiment according to FIG. 7,

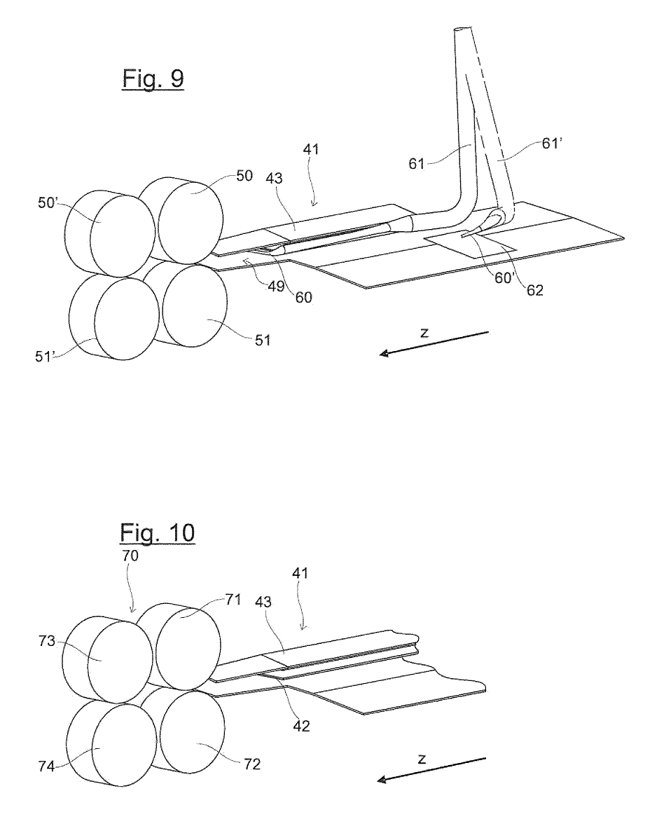

FIG. 9 shows an exemplary embodiment with an extrusion device, and

FIG. 10 shows an exemplary embodiment with an ultrasonic welding device.

FIG. 1 schematically shows individual steps for processing a plastic-containing hose such as, for example, a sheet hose or a hose consisting of layered fabric to bags such as are made in the bag manufacturing device 1.

At first, the hose 2 is supplied to the bag producing device 1. This advantageously takes place during the winding off of the hose forming a winding 3 in a winding-off device 4. The hose 2 can subsequently experience the so-called opening in the optional opening station 5, which is preferably used in the case of a fabric hose. At this time the hose is guided around an inner tool which separates the two layers from one another so that the layers separate if they were glued to one another in one of the production steps of the hose. It can only be ensured in the case of separated layers that the following production steps can be properly carried out. The material layers of the hose separated from each other in this manner are subsequently placed on each other again.

The hose is now supplied to the transverse cutting device 6 which individualizes the hose into individual hose pieces 20.

The changing of the original transport direction z in which the hose or the hose pieces were transported in the direction of the longitudinal axes (so-called longitudinal transport) subsequently takes place into the new transport direction y so that the hose pieces are now no longer transported in the direction y of their hose longitudinal axis (also called the direction of extension of the hose pieces in the following) but rather are transported transversely to it (so-called transverse transport) so that the ends of the hose pieces can be reached from the side for forming the bottoms.

In the following station, the bottom opening station 8, both ends of each hose piece are opened and the so-called bottom rectangles are placed. In the following valve station 9 a valve is placed on one of the two open ends of the hose piece and is fastened. The open bottoms are now closed in the bottom closing station 10, wherein two side tabs are folded over along two folding edges and are partially placed on one another. The application of a bottom cover sheet onto each of the bottoms in the cover sheet station 11 forms the closure of the actual bag production process, wherein the cover sheet is connected to areas of the two side tabs and to areas of the triangular pockets. To this end the cover sheets can be sealed on or glued on. The finished bags are subsequently placed on the bag stack 12 and removed from there in a manner not described in detail.

FIG. 2.1 clarifies the steps for forming bottoms onto the hose piece 20, wherein the hose piece can be brought by the transport device 19 to the individual stations with which the steps for forming bottoms on hose pieces can be carried out. In the view a) at least one end, preferably both ends of the hose piece are pulled, wherein the upper layer is folded back along the middle bottom line 21 so that the bottom rectangle 22 and the triangular pockets 23 are formed. In this view the second folding edges 24 are sketched in with dotted lines around which the side tabs 25, 26, with which the areas on the far side of the second folding edges are designated, are folded.

In step c) and d) the side tabs 25 and 26 are folded around these two folding edges, which preferably takes place slightly offset in time in order not to produce any disturbance. A placed bottom 27 is now produced. A so-called valve card 30 was previously fastened in step b) onto a triangular pocket which card subsequently makes an opening available for filling the finished bag.

In the concluding step e) a cover sheet 31 is fastened in such a manner onto the bag bottom that both side tabs are connected to one another and to the triangular pockets on both adjacent sides.

In order to understand the present invention, shaded rectangles were sketched in the view a) which are provided directly adjacent to the folding edges or to the connection areas 32 overlapping with folding edges. The latter are shown only on one triangular pocket but such connection areas can be provided on several or on all triangular pockets. If a valve is to be provided, connection areas in the area of the valve are not necessary. FIG. 2.2 shows the concerned area in an enlarged view. The connection area is shown in each instance only on one side of the folding line but it is immediately clear that after the folding over of the side flaps 24, 25 the connection surface also acts on the folded-over side flaps 24, 25 so that it can also be said that the connection surface lies on both sides of the second folding edges.

FIGS. 3.1 and 3.2 show a first embodiment of the invention in which a track of glue 34 consisting of heat-actuatable glue (so-called hot-melt glue) is applied onto the triangular pockets along the (later) second fold edges 24. A hot-melt connection cannot produce any carrying connection but this is also not necessary at the cited position and for the cited, sealing function, so that the economical hot melt has cost advantages here.

However, in FIG. 3.1 the bottom has not yet been pulled, so that the glue tracks supposedly do not lie on the second folding edges. Nevertheless, the glue tracks on the projections 35 of the second folding edges 24 lie on the triangular pockets 23. The glue tracks are of course to be applied in a congruent manner on the back side (not shown) of the hose piece. The application of a glue takes place in this exemplary embodiment preferably during the longitudinal transport of the hose or of a hose piece or in a standstill phase during the longitudinal transport. There is a time period here in which a hose piece is individualized from the hose. Since the warm glue applied rapidly hardens and therefore becomes solid, there is no hindering or even no disturbance of the following processing steps. The providing of an application of glue at this position has the great advantage of a simple system integration of a glue application device.

In FIG. 3.2 the bottom has already been pulled, so that the already-described glue tracks 34 are directly applied along the second folding edges onto the triangular pockets, that is, after the hose pieces have passed the bottom opening station.

The actual connecting and therefore the producing of sealing connections between the side tabs and the triangular pockets, preferably in the areas which are not covered by the bottom cover sheet, takes place now by a charging of heat. A charging of heat advantageously takes place with the device for sealing a bottom cover sheet 31 onto the placed bottom 27. This takes place in the cover sheet station 11 already explained in conjunction with FIG. 1. The FIG. 1 of the patented DE 195 022 52 C2 as well as the associated specification passages of columns 2 and 3 describe the components and the manner of functioning of such a cover sheet station 11. The cited disclosure parts of DE 195 022 55 C2 are therefore components of the present patent application here since they form a combination which is preferred in conjunction with the just-described exemplary embodiment of the present invention.

FIG. 4 shows another advantageous exemplary embodiment of the present invention. This figure shows a folding-over element 41 by way of example which is a component of a bottom closing station and with which the side tab 26 is folded back along the second folding edge 24 onto the open bottom. Up to four folding-over elements are provided on a bottom forming device in order to be able to fold over all side tabs. It is very advantageous here if the folding-over element 41 has a U-shaped form, wherein the typical bottom develops to an edge in the further course in direction z in order to be able to successively carry out the folding-over without forces which are too great acting of the side tab, which might result in an oblique position of the second folding edge or in other errors. The U-shape of the folding element 41 can be readily recognized in FIG. 5, which represents a cross section. An advantageous embodiment can be recognized in which the hose piece end can be guided or is guided between an inner guiding element 42 and an outer guiding element 43. It can be recognized in FIG. 6, which shows a cross section of the folding-over element 41 at a position in the further course of the transportation, that the two guiding elements now have a more pronounced tip for forming the second folding edge.

In addition, FIG. 4 shows a hot-air device 44 which comprises at least an air supply 45, a heating element 46 and a tube 47 for guiding the hot air to the hot-air sealing position. The tube 47 empties into a hot-air nozzle 48 shows in FIG. 6. The hot-air nozzle is preferably a wide-slot nozzle which is distinguished in that its cross section has a width which is at least three times its height.

FIG. 7 shows a perspective view of a part of the bottom closing station with a folding-over element 41. It can be recognized that the inner guide element 42 is shorter than the outer guide element 43 and that the hot-air nozzle 48 is arranged in the end area of the inner guide element 42 so that the hot air can be directly blown in the direction z over the end of the inner guide element 42 into the area between the side tab and the triangular pocket directly onto and/or into the folding edge. The position at which this takes place can be designated as joint position 49. For the sake of a better illustration of the machine components, the hose piece with the bottom to be placed is not shown. Furthermore, a roller slot is visible which is formed by the rollers 50, 51. This slot serves to compress and therefore to better connect the areas sealed with hot air. The rollers can be designed to be tempered, in particular to be cooled. A second roller pair 50′, 51′ can be provided.

However, since the side tabs are to be connected to the triangular pockets but not to the open bottom rectangle and therefore to the interior of the bag, there are two alternatives which have advantages. On the one hand, at least the tube 47 together with the nozzle 48 can be is designed to be pivotable. In this pivoted position the tube is shown with interrupted lines and the reference number 47′. On the other hand, the current of hot air can also be interrupted in that, for example, a valve (not shown) is provided in the tube. In both cases a control is provided with which the current of hot air is blown in cycles into the joint position 49.

FIG. 8 shows the situation of FIG. 7 in a top view and with a hose piece 20 which is located directly in front of the inlet into the folding-over element 41.

FIG. 9 shows another exemplary embodiment of the invention which is designed similarly to the exemplary embodiment in FIG. 7. However, the hot-air nozzle is replaced here by an extrusion nozzle 60 with which an extrudate can be delivered directly onto or into the second folding edge.

The extrudate can also be supplied by a tube 61. The extrudate is supplied from an extruder (not shown) in which plastic is liquified. The tube 61 can also be pivoted into the position 61′ in this exemplary embodiment in order to not allow any undesired connection, for example between the side tab and the bottom rectangle to be created. A catch element 62 for catching any extrudate dropping down can be provided underneath the extrusion nozzle 60′. As in the exemplary embodiment of FIG. 7, a roller pair 50, 51 can be provided following the joining position, which roller pair additionally compresses the side tab and triangular pockets which are connected to each other while the hot and therefore liquified material hardens.

FIG. 10 shows another advantageous exemplary embodiment of the invention in which an ultrasonic welding device 70 is provided for welding side tabs and triangular pockets. This ultrasonic welding device comprises a combination consisting of a sonotrode 71 and an anvil 72. In FIG. 10 these two elements are shown as rollers but it is also possible to shape them differently. If the welding is to take place during the transport, at least one of the two cited components can be, for example, rotary or oscillating. In the cycled advance of the hose pieces at least one of the two components can stand still. However, even in the case of a continuous transport of the hose pieces one component can stand still. The other components of the bottom closing station can be designed as in the exemplary embodiment of FIGS. 4 to 9. In particular, the roller pair 73, 74 can again serve for compressing and/or cooling the connection position 32.

Various features were disclosed in combination with individual exemplary embodiments in the scope of the present description. However, it is possible or even desirable to also combine such features with other exemplary embodiments. The above description is therefore not limited to the feature combinations disclosed in it.

List of reference numerals

| | |
|---|---|
| 1 | Bag production device |
| 2 | Hose |
| 3 | Winding |
| 4 | Winding-off device |
| 5 | Opening station |
| 6 | Transverse cutting device |
| 7 | Bottom opening station |
| 8 | Valve station |
| 9 | Bottom closing station |
| 10 | Cover sheet station |
| 11 | Bag stack |
| 12 | Transport device |
| 13 | Hose piece |
| 14 | Bottom middle line |
| 15 | Bottom rectangle |
| 16 | Triangular pocket |
| 17 | Folding edge |
| 18 | Side tab |
| 19 | Side tab |
| 27 | Placed bottom |
| 30 | Valve card |
| 31 | Bottom cover sheet |
| 32 | Connection area |
| 34 | Glue track |
| 35 | Projection |
| 41 | Folding-over element |
| 42 | Inner guide element |
| 43 | Outer guide element |
| 44 | Hot-air device |
| 45 | Air supply |
| 46 | Heating element |
| 47 | Tube |
| 48 | Hot-air nozzle |
| 49 | Joint position |
| 50 | Roller pair |
| 51 | Roller pair |
| 60 | Extrusion nozzle |
| 60′ | Extrusion nozzle |
| 61 | Tube |
| 61′ | Tube position |
| 62 | Catch element |
| 70 | Ultrasonic welding device |
| 71 | Sonotrode |
| 72 | Anvil |
| 73 | Roller pair |
| 74 | Roller pair |
| y | New transport direction |
| z | Transport direction |

1. A method for forming at least one bottom on a hose piece, which comprises plastic material, in which
at least one end of the hose piece is pulled under formation of a bottom rectangle and triangular pockets along at least one first folding edge,
for closing the bottom, side tabs of the bottom rectangle are folded back along second folding edges which are at a distance from the first folding edge, wherein the two side tabs subsequently contact one another, and
a bottom cover sheet is placed on the bottom and is connected by the action of heat or by a glue to the side tabs and to at least one triangular pocket, wherein the surfaces of the side tabs, which surfaces come in contact, and the triangular pockets are connected at least in the area of the second folding edges, forming a connection with each other.

2. The method according to claim 1, wherein
the connection extends at least over an area which is removed by 1 cm from the second folding edge.

3. The method according to claim 1, wherein
the connection of the surfaces of the side tabs, which surfaces come in contact, and the triangular pockets comprises at least the area of the particular intersection of the second folding edges and of the diagonals of the triangles.

4. The method according to claim 3, wherein
the connection, viewed from the intersection, extends at least 1 cm in the direction of the particular second folding edge.

5. The method according to claim 1, wherein
the connection is produced by a hot-air sealing.

6. The method according to claim 1, wherein
the connection is produced by an ultrasonic welding.

7. The method according to claim 1, wherein
the connection is produced by an application of glue.

8. The method according to claim 7, wherein
the application of glue is made before the folding back of the side tabs, preferably before the pulling of the bottom.

9. The method according to claim 7, wherein
a heat-activatable hot melt is applied as an application of glue.

10. A device for forming at least one bottom on a hose piece, which comprises plastic material, with
a bottom opening device for pulling at least one end of the hose piece under formation of a bottom rectangle and triangular pockets along at least one first folding edge,
a bottom closing device for closing the bottom with which side tabs of the bottom rectangle can be folded back along second folding edges which are at a distance from the first folding edge, wherein the two side tabs contact one another subsequently, and
a cover sheet application device for applying a bottom cover sheet onto the bottom and for connecting the bottom cover sheet to the tabs and to at least one triangular pocket by the action of heat or by a glue, wherein
a device for producing a connection is provided with which the surfaces of the side tabs, which surface come in contact, and the triangular pockets can be connected to each other at least in the area of the second folding edges, forming a connection with each other.
